(19) United States
(12) Patent Application Publication
(10) Pub. No.: US 2022/0099428 A1
(43) Pub. Date: Mar. 31, 2022

(54) ROTATION ANGLE CAPTURE WITH A 3-D SENSOR AND AN AXIS OF ROTATION PARALLEL TO A PRINTED CIRCUIT BOARD

(71) Applicant: ZF Friedrichshafen AG, Friedrichshafen (DE)

(72) Inventor: Jürgen GRIES, Lage (DE)

(73) Assignee: ZF Friedrichshafen AG, Friedrichshafen (DE)

(21) Appl. No.: 17/298,461

(22) PCT Filed: Nov. 27, 2019
(86) PCT No.: PCT/EP2019/082743

§ 371 Date: May 28, 2021

(30) Foreign Application Priority Data
Nov. 30, 2018 (DE) 10 2018 220 665.1

(51) Int. Cl. G01B 7/30; G01D 5/14; G01D 5/244

(52) U.S. Cl. CPC G01B 7/30; G01D 5/24433; G01D 5/145

(57) ABSTRACT

In a sensor arrangement for determining a rotation angle of a magnet about an axis of rotation, with a sensor for capturing a radial component and a tangential component of the measuring field of the magnet and for determining the rotation angle on the basis of an atan function, the sensor is mounted, at a radial distance from the axis of rotation, on a printed circuit board parallel to the axis of rotation and is offset by an axial distance. In a design method, an initial axial distance and radial distance are selected, the profile is determined, and the axial distance and/or the radial distance is/are iteratively optimized. A selector lever is coupled in terms of movement to the magnet of the sensor arrangement. The sensor arrangement is optimized and installed with the selector lever, and a compensation arrangement is adjusted.

The invention relates to a sensor arrangement, to a design method for the sensor arrangement, to a selector lever arrangement and to a fabrication method for the selector lever arrangement.

Conventional magnetic rotation angle sensor systems, such as are illustrated by way of example in FIG. 4, use, for the detection of an actual rotation angle WT in the form of a determined rotation angle WE about an axis of rotation 12, a diametrically magnetized magnet 6 which is mounted on a shaft 10. The SMD sensor element in the form of a sensor 18 is positioned underneath the magnet 6 on a printed circuit board 20 and uses the arctangent (atan) function and the planar field components Bx and By (of the field of the magnet) which run parallel to the plane 20 of the printed circuit board to calculate the (determined) rotation angle WE of the rotating encoder magnet (magnet 6). In this arrangement, the axis of rotation 12 of the magnet 6 is positioned perpendicularly on the plane of the printed circuit board or on the printed circuit board 20 or on the surface 22 thereof.

The object of the present invention is to specify improvements with respect to the rotation angle capture.

The object is achieved by means of a sensor arrangement as claimed in patent claim 1. Preferred or advantageous embodiments of the invention and other invention categories become apparent from the further claims, the following description and the appended figures.

The sensor arrangement serves to determine a rotation angle of a magnet about an axis of rotation. The rotation angle is that of the magnet about the axis of rotation relative to a base carrier. The sensor arrangement contains the base carrier and the magnet. The magnet can rotate relative to the base carrier about the axis of rotation. The magnet has, in particular with respect to the axis of rotation, a diametrical or radial or arcuate or sinusoidal magnetization direction. The geometry of the magnet is, in particular, round or cylindrical, but it can also be formed in any other shape. The magnet serves to generate a magnetic measuring field, or the magnet generates the measuring field at least while the sensor arrangement is operating. The magnet is, in particular, a permanent magnet.

The sensor arrangement contains a sensor. The sensor is in particular a Hall sensor. The sensor is arranged in a positionally fixed fashion relative to the base carrier. The sensor serves to capture a radial component and a tangential component of the measuring field. The corresponding radial direction and tangential direction are to be understood with respect to the axis of rotation. The tangential component is the component in the direction of rotation. The sensor serves to determine the rotation angle from the radial component which is captured by the sensor at the location of the sensor, and to determine the tangential component which is captured by the sensor at the location of the sensor. The determination by means of the sensor on the basis of the components is carried out on the basis of an arctangent function (atan function).

The sensor is mounted on a printed circuit board next to the axis of rotation with a radial distance from the axis of rotation and electrically contact-connected to said printed circuit board or the conductor tracks etc. thereof. The printed circuit board is part of the sensor arrangement. The printed circuit board is mounted in a positionally fixed fashion with respect to the base carrier. A surface of the printed circuit board runs parallel and tangentially with respect to the axis of rotation, at least on the sensor or at the location of the sensor or in the region of the sensor. The magnet has a central plane, in particular a plane of symmetry, lying transversely or perpendicularly with respect to the axis of rotation. The central plane can also run through the center of gravity of said magnet. The sensor is arranged offset with respect to a central plane of the magnet in the axial direction of the axis of rotation by an axial distance. The axial distance is different from zero. The invention is based on the realization that although with the classic rotation angle capture according to FIG. 4 there is a very large range of high signal linearity directly underneath the magnet. With the axis-parallel arrangement, however, the linear signal range is very small and is not located directly under the magnet. This linear range is dependent on the material of the magnet, on the size of the magnet and the shape of the magnet, on the type of magnetization and on the distance of the sensor (radial/axial) from the magnet (center of the magnet). This range has to be determined in order to be able to use the axis-parallel arrangement with a linear sensor output signal.

The magnet or sensor are therefore positioned opposite one another with an axial offset or have an axial offset. The two components, magnet and sensor, are therefore not positioned or installed symmetrically.

In one preferred embodiment, the axial distance and the radial distance are therefore selected in such a way that a profile of the rotation angle which is determined by the sensor, plotted against the actual rotation angle of the magnet (given a linear-linear application), is optimized in terms of its linearity to an error metric between the determined rotation angle (WE) and the actual rotation angle (WT), and that the determined rotation angle corresponds in each case as precisely as possible to the actual rotation angle. In this context, the error metric corresponds to a maximum error of 10° with respect to one full rotation of the magnet through 360°. The error is preferably less than 5°, preferably less than 3°, and preferably less than 2°.

According to this embodiment, an error framework for the determined rotation angle with respect to the actual rotation angle (360° in the case of one full rotation of the magnet about the axis of rotation) is thus defined. Error profiles are obtained by selecting different sensor positions with respect to the magnet. Corresponding curves or profiles deviate very quickly from the ideal profile, also with a certain regularity. The profiles show to a certain extent errors of approximately 40 degrees or more with respect to the ideal case. Such large errors in an output of the sensor arrangement with respect to the actual rotation angle and such sensor arrangements generally can no longer be appropriately used.

Additional sources of errors are in any case also mechanical tolerances such as for example a tilted position of the magnet. For example, errors of ±4 degrees or of +1.65 degrees and −1.55 degrees can be realistically achieved and are acceptable. Even Hall plates themselves in a sensor are installed with e.g. 0.3 millimeter tolerances. That is to say, if the fact that sensor positions are e.g. respectively shifted iteratively by 0.5 millimeters is taken into account, it is increasingly difficult from a practical point of view to arrive at a precise linearity.

The profiles of the radial component and of the tangential component of the measuring field at the location of the sensor are already non-ideally sinusoidal or cosinusoidal solely owing to the theoretical arrangement geometry but also owing to tolerances, inaccuracies, real field distortions etc. Therefore, a back-evaluation using the atan function in the form of the rotation angle determined by the sensor does not precisely provide the actual rotation angle of the magnet. A characteristic curve in which the profile of the determined rotation angle is plotted against the actual rotation angle therefore does not correspond precisely to the ideal profile of the actual rotation angle, and is in particular therefore not precisely linear but rather bulges in particular in an S shape.

By varying parameters of the arrangement, at least the axial distance and/or radial distance, the profile of the actually determined rotation angle changes. According to the invention, the axial distance and/or radial distance are varied in such a way or for long enough until a combination of the axial distance and radial distance is found at which the deviation between the determined rotation angle and actual rotation angle (in particular within all the tested positions) is minimized within the limits of the corresponding variation (that is to say within the limits of the possible positions taken into consideration, in particular a limited selection thereof). In particular, in this context, the corresponding sizes are checked and the optimum raster point (radial distance/axial distance) for the positioning of the sensor is selected in a radial-axial plane of the axis of rotation in a raster shape, with a suitable raster interval and a suitable number of raster points, at all raster points. A person skilled in the art has a multiplicity of selection possibilities both for a corresponding optimization process and for a corresponding measure to be optimized of the deviation between the determined rotation angle and the actual rotation angle. The person skilled in the art is able here to make a suitable selection for a sensor arrangement which is actually present.

The measuring field is anchored in a co-rotational fashion to the magnet, that is to say rotates along with it about the axis of rotation. The atan determination from two components is sufficiently known to the person skilled in the art and is not intended to be explained in more detail here. The “rotation angle” can be an actual absolute angle value, e.g. in degrees, or any measure which is clearly correlated to the rotation angle.

The printed circuit board therefore runs “parallel” to the axis of rotation at the location of the sensor. This permits in particular SMD (surface mounted device) mounting of an SMD sensor for component capture only in the corresponding plane or on the surface of the printed circuit board. According to the invention, a sensor is selected which in its corresponding mounted position can determine corresponding components parallel (tangential component) and perpendicularly with respect to the printed circuit board (radial component). The printed circuit board surface serves for the mounting of the sensor. The sensor is therefore, as expressed in the specialist jargon, arranged “underneath” the axis of rotation and “offset underneath” the magnet.

In relation to the printed circuit board and the sensor (at the location of the sensor), the “tangential component” is therefore a planar field component or a parallel field component with respect to the axial direction of the axis of rotation. The “radial component”, on the other hand, is a vertical or perpendicular field component with respect to the printed circuit board and the sensor, and a radial field component with respect to the axial direction.

The axis of rotation of the magnet therefore runs parallel to and at a distance from the printed circuit board surface. It is also possible for the axis of rotation to be understood as a magnet axis, and the magnet to be understood as an encoder magnet.

The invention is based on the following ideas and realizations: an arrangement in which the axis of rotation of the magnet runs perpendicularly with respect to the printed circuit board can be in practice no longer be implemented cost-effectively, in particular if a (second) axis (of rotation) at which a rotational movement is to be picked up is to run parallel to the printed circuit board. In that case, the movement of the second axis of rotation would have to be turned around through 90° onto the first axis of rotation of the magnet, e.g. by means of a transmission, so that the above structural arrangement (FIG. 4, axis of rotation of the magnet perpendicular to the printed circuit board) is brought about. As an alternative, wired components (THT—through hole technology) could also be used for the sensor instead of an SMD sensor. In this way, the sensing direction of the sensor could also be rotated through 90° with respect to SMD components, and the axis of rotation of the magnet could run parallel to the printed circuit board. It would then no longer be necessary to mechanically turn around the rotational movement through 90°. However, the THT technology is not desirable owing to the more costly fabrication.

The present invention therefore describes an arrangement between a magnet axis (axis of rotation) and printed circuit board which makes it possible to detect a rotation angle of the encoder magnet even with a parallel axis orientation of the magnet (of the axis of rotation) with respect to the printed circuit board. For this purpose, a diametrically magnetized magnet, e.g. ring magnet, is used again and an SMD sensor element, which, however, can capture one vertical field component (“Bz”) and one planar field component (Bx/By) instead of the planar field components (“Bx, By”, with respect to the printed circuit board or its surface or its plane), and can therefore evaluate by means of the atan function.

Furthermore, according to the invention, the (SMD) sensor is no longer to be positioned precisely centrally below the magnet 89 (in the central plane) but rather offset somewhat with respect to the axial plane of symmetry (or central plane) of the magnet. This structural offset provides a characteristic curve (of the measured rotation angle) which is as linear as possible, plotted against the (actual) rotation angle (of the magnet). In addition, the best possible modulation of the sensor is optionally ensured with respect to the induction range of the sensor. The selection of the structural offset is then also determined by means of the lower or upper induction operating range of the sensor (sensor element). According to the invention it is possible to find, in particular by means of field calculations, a sensor point (mounting location of the sensor) which forms the best possible linearity of the determined rotation angle (signal linearity) or the best possible compromise between the signal linearity and modulation of the sensor.

Using the sensor arrangement according to the invention, it is possible to obtain a virtually linear (determined) rotation angle signal (profile of the determined rotation angle). The remaining residual error can occur, in particular, via linearization of the characteristic curve at the end of a fabrication line (EOL) in which the sensor system is contained or used.

In one preferred embodiment of the invention, the profile is optimized to the effect that a compromise between the linearity of the profile and a modulation of the sensor is optimized. As already mentioned above, in that case not only is the signal linearity optimized but also the induction operating range of the sensor is taken into account and the corresponding compromise optimized.

In this context, the amplitude of the measuring field at the location of the sensor for the respective actual rotation angle is therefore also taken into account. The “modulation” is understood to be with respect to the induction range of the sensor. The modulation is therefore limited by the lower and upper induction operating ranges, e.g. 20-100 mT. In particular, a compromise of 50-60 mT is selected for the modulation. Therefore, according to the invention, the best possible compromise between the sensor modulation and the signal linearity (as explained above in the context of the possibilities taken into consideration) can be found.

In one preferred embodiment, the profile of the captured rotation angle and—if it is present, i.e. for the abovementioned embodiment with a compromise between linearity and modulation—the profile of the modulation has been (in the finished sensor arrangement) or is (when designing the sensor arrangement) optimized on the basis of an FEM analysis of the measuring field. The FEM analysis takes place here at least at the location of the sensor. The corresponding optimization can then be carried out theoretically or on a computer, and trials or measurements are not necessary for this.

In one preferred variant of this embodiment, the optimization has been or is carried out in such a way that, of axial distances and radial distances which can be predefined on the basis of a rasterized FEM analysis, such a pair has been or is selected which has a comparatively optimum linearity of the profile (or optimum results also in respect of other embodiments, e.g. the abovementioned compromise). A corresponding procedure has already been described above e.g. on the basis of a corresponding “raster”. The raster intervals are here in particular at least 0.1 mm or at least 0.2 mm or at least 0.3 mm or at least 0.4 mm or at least 0.5 mm or at least 1 mm. The raster intervals are in particular at maximum 1.5 mm or at maximum 1 mm or at maximum 0.75 mm or at maximum 0.5 mm or at maximum 0.3 mm or at maximum 0.1 mm.

If the position of the sensor underneath the magnet is correctly selected, the signal error can be minimized with respect to adjacent positions to a great enough extent that the raw (non-linearized) sensor signal has an error down to virtually zero. If e.g. the sensor positions are 0.5 mm away from one another, the error for the optimized position is less than 4° with respect to the ideal sensor straight line. A virtually ideal signal (error almost zero) can be achieved with an even finer increment.

The term “can be predefined” is understood here to mean in particular a technically practice-conforming number, as small as possible but sufficient, of raster points which are to be examined, but which are sufficiently dense or positioned in technically appropriately stepped intervals in a correspondingly appropriately appearing radial-axial range.

In one preferred embodiment, the magnet is connected in a co-rotational, in particular fixed, fashion to a shaft which runs along the axis of rotation. The magnet is therefore rotatable together with the shaft about the axis of rotation. The shaft can then serve to take up a rotation signal which is to be captured and which is then transferred directly to the magnet and therefore to the determined rotation angle.

In one preferred embodiment, the sensor is an SMD sensor which is mounted and electrically contact-connected on a surface of the printed circuit board. The corresponding advantages have already been explained above. In particular, in this way the known advantages of the SMD technology can be used for the present invention.

In one preferred embodiment, the sensor is a 3-D sensor. This can be a “genuine” 3-D sensor which can actually evaluate three field components which are perpendicular to one another. However, the sensor can also be one which can effectively output only two captured field components but the respective capturing direction can be programmed in the sensor. Owing to corresponding sensors it is possible to capture in particular the radial component, that is to say the field component of the measuring field, perpendicularly to the plane of the printed circuit board even when an SMD sensor is used.

In one preferred embodiment, within the scope of the optimization of the profile of the determined rotation angle—and of further optimizations if they are present—the material of the magnet and/or the volume of the magnet are/is also varied or selected in addition to the axial distance and the radial distance, in such a way that the profile of the determined rotation angle (etc.) is optimized. Therefore, additional variable parameters are available in order to arrive at further improved results. The above embodiments for optimizing the axial distance and radial distance are then appropriately extended to further parameters.

In one preferred embodiment, the sensor arrangement contains an adjustable compensation arrangement. This serves to compensate a residual error in the determined rotation angle with respect to the actual rotation angle. A residual error is generally also present after the optimization, this is because even using the best possible optimization precise correspondence between the determined rotation angle and actual rotation angle is generally not possible. The corresponding residual error can then be compensated by the compensation arrangement at least to a greater extent or even completely. The compensation arrangement can contain, for example, scaling of measurement variables or addition of correction values. The person skilled in the art is presented with a wide selection here.

The object of the invention is also achieved by means of a design method as claimed in patent claim 11 for the sensor arrangement according to the invention, in which the axial distance and the radial distance are selected in such a way that a profile of the determined rotation angle plotted against the actual rotation angle is optimized with respect to its linearity to an error metric between the determined rotation angle and the actual rotation angle. In the method, an initial axial distance and radial distance (and optionally starting values for further parameters according to the embodiments specified above) are selected. A profile of the determined rotation angle is subsequently determined. According to one iteration method, the axial distance and/or the radial distance (and/or the further parameters) are subsequently varied in order to optimize the profile as explained above.

The method and at least some of its embodiments as well as the respective advantages have been correspondingly explained already in conjunction with the sensor arrangement according to the invention.

In one preferred embodiment, the design method is carried out using an FEM (finite element method for electromagnetic fields) analysis of the measuring field for the respective current axial distance and radial distance (or in other embodiments for respectively changed parameters, e.g. selection of material, volume of magnet etc.). This method variant has also already correspondingly been explained above.

The object of the invention is also achieved by means of a selector lever arrangement as claimed in patent claim 13 for a vehicle, having a selector lever which can be moved between at least two positions in order to select a vehicle function, and having a sensor arrangement according to the invention, wherein the selector lever is kinetically coupled to the magnet, and the positions can be differentiated by means of the determined rotation angle. In this way, the position and the change therein can be inferred on the basis of the determined rotation angle.

The advantages which have already been correspondingly explained above for the sensor arrangement and the design method are therefore also reflected in corresponding selector lever arrangements. In particular, a sensor arrangement which has a characteristic curve, optimized in terms of its linearity, relating to the determined rotation angle and actual rotation angle is therefore already available within the selector lever arrangement. For further optimization of the selector lever arrangement or of the installed sensor arrangement all that then is necessary is to optimize the residual structure connected downstream in accordance with the sensor arrangement. The selector lever arrangement is in particular one for selecting a drive position and/or gear stage in a vehicle. The vehicle is in particular an automobile, in particular with semi-automatic/automatic transmission with different drive positions and/or gear stages which can be selected by means of the selector lever.

In one preferred embodiment, in connection with a sensor arrangement with a compensation arrangement, the compensation arrangement has been or is set during its fabrication within the scope of an end-of-line setting with respect to the selector lever arrangement. On the basis of the already optimized sensor arrangement, the compensation arrangement consequently only has to perform the abovementioned residual compensation within the selector lever arrangement still, and can therefore be set particularly easily and at low cost.

The object of the invention is also achieved by means of a fabrication method as claimed in patent claim 15 for a selector lever arrangement according to the invention with a compensation arrangement. In the method, the sensor arrangement is optimized. Subsequently, the sensor arrangement is installed with or in the selector lever arrangement. Finally, the compensation arrangement is set within the scope of the end-of-line setting.

The method and at least some of its embodiments as well as the respective advantages have correspondingly already been explained in conjunction with the selector lever arrangement according to the invention.

Further features, effects and advantages of the invention can be found in the following description of a preferred exemplary embodiment of the invention and the appended figures. In this context, in each case in a schematic basic diagram:

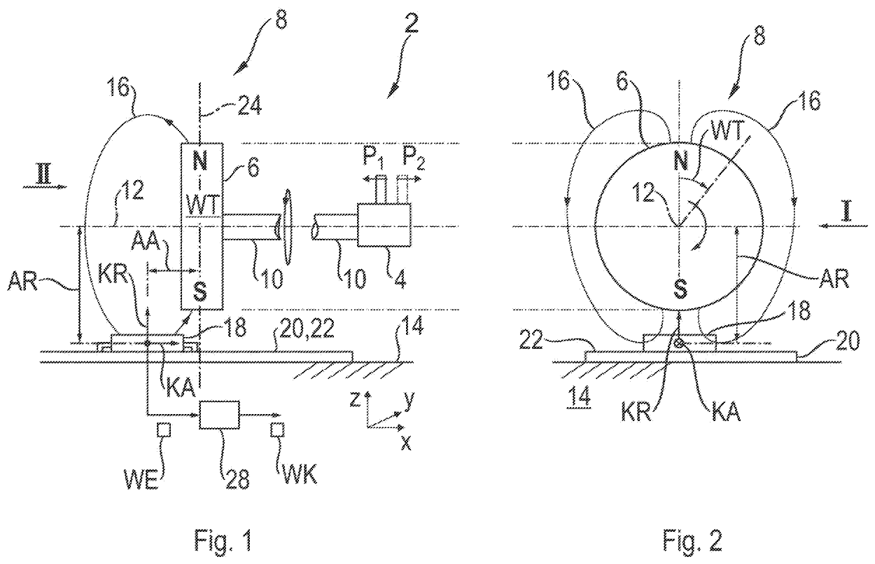

FIG. 1 shows a selector lever arrangement according to the invention with a sensor arrangement in a side view,

FIG. 2 shows the sensor arrangement from FIG. 1 in a front view,

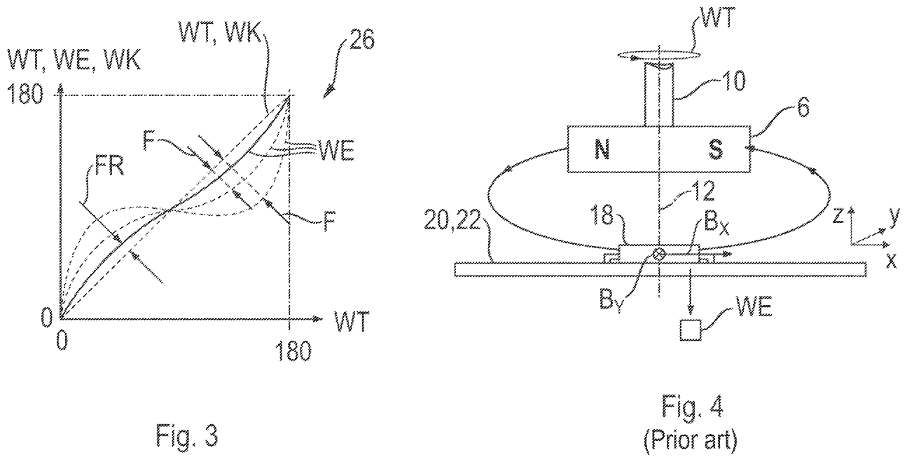

FIG. 3 shows a diagram with a determined rotation angle, plotted against an actual rotation angle,

FIG. 4 shows a rotation angle sensor system according to the prior art,

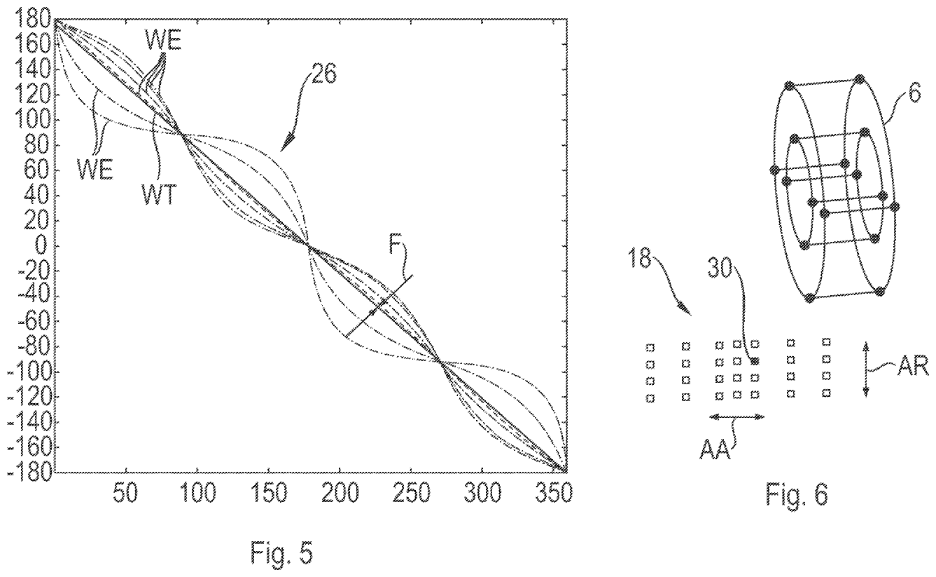

FIG. 5 shows a diagram of determined rotation angles plotted against an actual rotation angle for various sensor positions, and

FIG. 6 shows the sensor positions for the determinations according to FIG. 5.

FIG. 1 shows a selector lever arrangement 2 for a vehicle (not illustrated in more detail), here an automobile, with a selector lever 4. The selector lever 4 can be moved between two positions P1,2, as indicated by arrows. A transmission stage (forward, reverse, parking, gear speed selection) in the automobile can be selected as a vehicle function by means of the selector lever 4 in a manner which is not explained in more detail. The current position of the selector lever 4 is to be detected, in order to be able to correspondingly actuate the transmission. For this purpose, the selector lever 4 is kinetically coupled to a magnet 6.

The kinetic coupling is carried out by mounting the magnet 6 in a co-rotational fashion on a shaft 10, wherein the selector lever 4 is in turn kinetically coupled to the shaft 10 in a manner which is not explained in more detail. The magnet 6 and shaft 10 can be rotated here about an axis of rotation 12 or rotated into a specific rotation angle WT depending on the position P1,2. In order to detect the positions P1,2, the actual rotation angle WT of the shaft 10 and therefore of the magnet 6 is to be determined. The magnet 6 is part of a sensor arrangement 8.

FIG. 2 shows once more the sensor arrangement 8 from FIG. 1 in a viewing direction of the arrow II from FIG. 1; FIG. 1 shows the viewing direction I from FIG. 2. The sensor arrangement 8 serves to determine a (determined) rotation angle WE which would correspond to the actual rotation angle WT in an ideal sensor arrangement.

The sensor arrangement 8 has a base carrier 14. The magnet 6 and shaft 10 can be rotated relative to the base carrier 14 about the axis of rotation 12. The magnet 6 is magnetized diametrically with respect to the axis of rotation 12 (indicated by the north pole N and south pole S). The magnet 6 is here a permanent magnet and generates a magnetic measuring field 16 which is coupled in a co-rotational fashion to the magnet 6 and is illustrated in the figures only by a small number of field lines.

The sensor arrangement 8 also contains a sensor 18, here a 3-D Hall sensor, which is mounted in a positionally fixed fashion with respect to the base carrier 14. The sensor 18 is configured to capture a radial component KR and a tangential component KT of the measuring field 16. The corresponding radial direction and tangential direction relate to the axis of rotation 12. The sensor 18 is configured to determine the rotation angle WE from the captured radial component KR and the captured tangential component KT on the basis of an arctangent (atan) function.

The sensor 18 is positioned at a radial distance AR from the axis of rotation 12. For this purpose, it is mounted and electrically contact-connected next to the axis of rotation 12, that is to say at a distance therefrom, on a printed circuit board 20. A surface 22 of the printed circuit board 20 is oriented parallel and tangentially with respect to the axis of rotation 12. In the example, the sensor 18 is an SMD component.

The sensor 18 is also arranged offset by an axial distance AA with respect to a central plane 24, here a plane of symmetry, lying transversely with respect to the axis of rotation 12, of the magnet 6.

FIG. 3 shows a profile 26 of the determined rotation angle WE (in degrees), plotted against the actual rotation angle WT (in degrees). In the sensor arrangement 8, the axial distance AA and the radial distance AR are selected in such a way that the profile 26 of the determined rotation angle WE plotted against the actual rotation angle WT is optimized with respect to its linearity. In the example, a quadratic error metric of a respective error F, i.e. of a deviation (indicated by a line) of the rotation angle WE perpendicularly from the profile of the rotation angle WT is minimized for realistically possible axial distances AA and radial distances AR.

The corresponding optimization or minimization has been carried out in the present case by means of a theoretical or modeled FEM analysis of the ratios for various axial distances AA and radial distances AR, until a comparatively optimum linearity, here the smallest possible error metric, was reached as illustrated in FIG. 3. Intermediate results for alternative values of the distances AA, AR are represented by dashed lines with errors F of different magnitudes.

In this context, variations of the material of the magnet and the volume of the magnet 6 have also been taken into account in the present case, and the error metric has correspondingly also been minimized with respect to these parameters. After the minimization, the optimized profile 26 which is illustrated by a solid line is obtained.

However, the respective optimization also takes into account the respective modulation of the sensor 18 by means of the measuring field 16 with possible axial distances AA and radial distances AR and magnetic parameters. An optimum compromise is selected in the present case between modulation and the most linear possible profile 26, and corresponding parameters (AA, AR, magnetic parameters) are found.

The sensor arrangement 8 also contains an adjustable compensation arrangement 28 in order to compensate the residual error FR between the rotation angle WE and the actual rotation angle WT to eliminate it completely here. According to one mapping function (not described here in more detail), the profile of the rotation angle WE is therefore optimized further and mapped onto respective values of a corrected rotation angle WK. The course of the rotation angle WK plotted against the rotation angle WT is also shown in FIG. 3 and is identical thereto, and therefore ideal.

In a design method for the sensor arrangement 8, initial values for the distances AA, AR and the magnet parameters are therefore firstly selected and these are varied with the abovementioned iteration method using a respective FEM analysis of a respective selection, which gives rise to the dashed curves in FIG. 3 with different error metrics. At the end of the iteration method, when there is a minimal error metric the solid-line profile 26 with the residual error FR is obtained.

The setting of the compensation arrangement 28 therefore takes place only after the optimization of the sensor arrangement 8 and its installation in the selector lever arrangement 2 within the scope of an EOL setting during the manufacture or fabrication of the selector lever arrangement 2.

FIG. 5 shows dashed-line alternative profiles 26 of determined rotation angles WE (in degrees, sensor signal), plotted against the actual (mechanical) rotation angle WT (solid line, in degrees). In this context, according to FIG. 6 axial distances AA and radial distances AR (variation indicated by arrows) are varied in the sensor arrangement 8. The illustrated curves in FIG. 5 correspond to some of the sensor positions indicated by dots. If the position of the sensor 18 underneath the magnet 6 is correctly selected (profile 26 with minimum deviation), the signal error with respect to adjacent positions (other profiles 26) can be minimized to a great enough extent that the raw (non-linearized) sensor signal has an error F down to virtually zero. In this example, the sensor positions are 0.5 mm away from one another, and the error F for the optimized position 30 is at <4° with respect to the ideal sensor straight line (WT). For relatively small distances of 0.25 mm, e.g. optimized profiles 26 (not illustrated) with a maximum error F of less than 0.5° are obtained.

### LIST OF REFERENCE SYMBOLS

2 Selector lever arrangement
4 Selector lever
6 Magnet
8 Sensor arrangement
10 Shaft
12 Axis of rotation
14 Base carrier
16 Measuring field
18 Sensor
20 Printed circuit board
22 Surface
24 Central plane
26 Profile
28 Compensation arrangement
30 Optimized position
P1,2 Position
WT Rotation angle (actual)
WE Rotation angle (determined)
WK Rotation angle (corrected)
N North pole
S South pole
KT Tangential component
KR Radial component
AA Axial distance
AR Radial distance
F Error
FR Residual error
Bx,y Field component

1. A sensor arrangement for determining a rotation angle of a magnet about an axis of rotation relative to a base carrier, the sensor arrangement comprising:
the base carrier;
the magnet configured to rotate relative to the base carrier about the axis of rotation to generate a magnetic measuring field;
a sensor positionally fixed relative to the base carrier and configured to:
capture a radial component and a tangential component of the measuring field with respect to the axis of rotation; and
determine the rotation angle from the captured radial component and the captured tangential component on the basis of an arctangent function,
wherein the sensor is mounted and electrically contact-connected next to the axis of rotation, with a radial distance from the axis of rotation, on a printed circuit board which is positionally fixed with respect to the base carrier, wherein a surface of the sensor runs parallel and tangentially with respect to the axis of rotation, and
wherein the sensor is arranged offset with respect to a central plane, lying transversely with respect to the axis of rotation, of the magnet in the axial direction of the axis of rotation by an axial distance which is different from zero.

2. The sensor arrangement of claim 1, wherein:
the axial distance and the radial distance are selected in such a way that a profile of the determined rotation angle, plotted against the actual rotation angle, is optimized in terms of its linearity to an error metric between the determined rotation angle and the actual rotation angle, wherein the error metric corresponds to a maximum error of 10° with respect to one full rotation of the magnet through 360°.

3. The sensor arrangement of claim 2, wherein:
the profile is optimized to the effect that a compromise between its linearity and a modulation of the sensor is optimized.

4. The sensor arrangement of claim 2, wherein:
the profile of the captured rotation angle is optimized on the basis of a finite element method (FEM) analysis of the measuring field at least at the location of the sensor.

5. The sensor arrangement of claim 4, wherein:
the optimization is carried out in such a way that, of axial distances and radial distances which can be predefined on the basis of a rasterized FEM analysis, ones are selected which supply a comparatively optimum linearity of the profile.

6. The sensor arrangement of claim 1, wherein:
the magnet is connected in a co-rotational fashion to a shaft which runs along the axis of rotation.

7. The sensor arrangement of claim 1, wherein:
the sensor is an SMD sensor which is mounted and electrically contact-connected on a surface of the printed circuit board.

8. The sensor arrangement of claim 1, wherein:
the sensor is a 3-D sensor.

9. The sensor arrangement of claim 2, wherein:
at least one of a material of the magnet or a volume of the magnet is selected in such a way that the profile is optimized.

10. The sensor arrangement of claim 1, wherein:
the sensor arrangement contains an adjustable compensation arrangement for compensating a residual error in the determined rotation angle with respect to the actual rotation angle.

11. A method for a sensor arrangement, the method comprising:
rotating a magnet relative to the base carrier about an axis of rotation relative to a base carrier to generate a magnetic measuring field;
capturing, with a sensor positionally fixed relative to the base carrier, a radial component and a tangential component of the measuring field with respect to the axis of rotation, wherein the sensor is mounted next to the axis of rotation with a radial distance from the axis of rotation, and is arranged offset with respect to a central plane, lying transversely with respect to the axis of rotation, of the magnet in the axial direction of the axis of rotation by an axial distance which is different from zero;
determining a rotation angle from the captured radial component and the captured tangential component on the basis of an arctangent function;
selecting an initial axial distance and radial distance;
determining a profile; and
iteratively varying at least one of the axial distance or the radial distance in order to optimize the profile.

12. The method of claim 11, wherein:
the design method is carried out using a finite element method (FEM) analysis of the measuring field for the respective current axial distance and radial distance.

13. A selector lever arrangement for a vehicle, comprising:
a selector lever which can be moved between at least two positions in order to select a vehicle function; and
the sensor arrangement of claim 10,
wherein the selector lever is kinetically coupled to the magnet, and the at least two positions can be differentiated by means of the determined rotation angle.

14. The selector lever arrangement of claim 13, wherein:
the compensation arrangement is set during its fabrication within the scope of an end-of-line setting with respect to the selector lever arrangement.

15. The method of claim 11, further comprising:
installing the sensor arrangement with a selector lever arrangement that can be moved between at least two positions in order to select a vehicle function, wherein the selector lever is kinetically coupled to the magnet and the at least two positions can be differentiated by means of the determined rotation angle; and
setting the compensation arrangement within the scope of an end-of-line setting with respect to the selector lever arrangement.

16. A selector lever arrangement for a vehicle, comprising:
a selector lever which can be moved between at least two positions in order to select a vehicle function; and
the sensor arrangement of claim 1,
wherein the selector lever is kinetically coupled to the magnet, and the at least two positions can be differentiated by means of the determined rotation angle.

17. The sensor arrangement of claim 3, wherein:
the profile of the captured rotation angle and the profile of the modulation is optimized on the basis of a finite element method (FEM) analysis of the measuring field at least at the location of the sensor.

18. The sensor arrangement of claim 17, wherein:
the optimization is carried out in such a way that, of axial distances and radial distances which can be predefined on the basis of a rasterized FEM analysis, ones are selected which supply a comparatively optimum linearity of the profile.
